(19) United States
(12) Patent Application Publication
(10) Pub. No.: US 2010/0324740 A1
(43) Pub. Date: Dec. 23, 2010

(54) METHOD FOR OPERATION OF A SECURITY GATE

(76) Inventor: Thomas Gallenschuetz, Buehl (DE)

Correspondence Address: COLLARD & ROE, P.C., 1077 NORTHERN BOULEVARD, ROSLYN, NY, 11576, US

(21) Appl. No.: 12/736,012

(22) PCT Filed: Feb. 26, 2009
(86) PCT No.: PCT/EP2009/052277

§ 371 Date: Sep. 1, 2010

(30) Foreign Application Priority Data
Mar. 6, 2008 (DE) 10 2008 013 060.5

(51) Int. Cl. G05B 15/00

(52) U.S. Cl. 700/275

(57) ABSTRACT

The invention relates to a method for operating a turnstile for the cyclical release of a passageway, wherein the turnstile comprises a control unit having a data memory and a data processing unit and comprising at least one blocking element that moves between a blocking position that blocks the passageway at a blocking point and a pass-through position that releases the passageway, wherein the at least one blocking element is connected to a moving support (10) in at least one direction of motion, the support comprising a first active surface (16a) or a plurality of first active surfaces (16a), wherein the turnstile comprises a locking device with at least one locking bar (18, 20) that can move between a first and a second end position and is intended to sit against the first active surface (16a) or one of the first active surfaces (16a) in one of its end positions. According to the invention, in a test run of the turnstile, in particular after it is started up, the control unit moves the locking bar (18, 20) to at least one of its end positions and moves the support (10) until the motion thereof is inhibited by the locking bar (18, 20), that the motion of the support (10) after a pre-determined distance is stopped if it is not inhibited by the locking bar (18, 20), that data characterizing the motion of the support (10) are collected by the control unit and that the data processing unit determines from the data characterizing the motion of the support (10) the parameters characterizing the turnstile, the data being stored in the data memory.

The invention relates to a method for operation of a security gate, in accordance with the preamble of claim 1.

Security gates for cyclical release of a passageway have at least one blocking element, such as a blocking crossbar, for example, which can be moved between a blocking position, which closes off the passageway, and a pass-through position, in which the passageway is released. The blocking crossbar is connected with a carrier, for example installed on a disk that is mounted in a fixed location, so as to rotate, by the movement of which disk the blocking crossbar is moved. In order to block the passageway, for example until a valid entry card has been inserted into a reader device, a blocking latch is provided, which inhibits movement of the carrier by lying against an active surface. The latch can be moved between a blocking position and a release position, whereby in the latter, the carrier is freely movable. If it is supposed to be possible to block and release the passageway in both directions, a second latch is present, which also comes to lie against one or more active surfaces of the carrier in its blocking position. For this purpose, the carrier has a second active surface that faces in the opposite direction, for each active surface.

When constructing a security gate and putting it into operation, the control device must be programmed. The control device must be provided with data as to what kind of security gate is present. The data contain, for example, information about whether the security gate has one or two lockable pass-through directions, how many latches are present, how many active surfaces for blocking are present, and whether the latches are in the blocking position in the current-free state, or in the release position. Such parameterization usually takes place by means of inputting corresponding parameter values into the control device itself or into an input device connected with the control device, by personnel trained to do so. For this purpose, either an input possibility or an interface on the control device is required. Furthermore, appropriately equipped and trained personnel is required, and this is very expensive, particularly in the case of decentralized production of the finished systems, for example when installing the systems on site.

It is therefore the task of the invention to further develop a method of the type stated initially, in such a manner that it is less expensive.

This task is accomplished, according to the invention, by means of a method having the characteristics of claim 1. Advantageous further developments are the object of the dependent claims.

The invention is based on the idea of making available an automatic configuration of the control device of a security gate. In this connection, advantage is taken of the fact that relevant properties of the security gate can be derived from its behavior in operation. Thus, only the data that characterize the movement of the carrier have to be determined in a test run, in order to provide the control device with the relevant data concerning number and type of latches and active surfaces. Automatic configuration already saves significant effort and expense when assembling the security gate and during startup. This is all the more relevant since security gates can be produced according to the modular principle, and therefore structural changes can be made even in existing security gates, by retrofitting them. Finally, it is also possible to carry out a test run during operation, during which test run changes in the security gate can be recognized, whether they have been brought about by intervention of an operator or due to wear.

The method is equally well suited for security gates having one latch that is intended to make contact with one or more first active surfaces of the carrier, and for security gates that can be blocked in two directions, which have two latches and active surfaces on the carrier that point in opposite directions of movement. In this connection, it is practical if the carrier is moved in both directions of movement, until it is inhibited by one of the latches, or until the predetermined path distance has been reached, with all possible combinations of the latch end positions. In particular, it is preferred that during the test run, the movement of the carrier until an active surface makes contact with one of the latches is repeated multiple times, particularly a predetermined number of times, for example until the latch in question has made contact with each of the related active surfaces. It is advantageous if the test run is repeated as many times as necessary until the control device can determine the relevant parameters of the security gate.

The method according to the invention can also be used to bring the security gate into a predetermined position, the so-called zero position, for example after a power failure. This position is characterized either in that one of the active surfaces can be differentiated from the other active surfaces, or that a group of active surfaces can be differentiated from the remaining active surfaces. The carrier then has a reference active surface or a group of reference active surfaces, whereby contact of one of the latches against one of the reference active surfaces defines the zero position or one of the zero positions. In order to set the zero position or one of the zero positions, the carrier is moved, during the test run, until the latch or one of the latches lies against the reference active surface of one of the reference active surfaces.

Preferably, the carrier is mounted in a fixed location, so as to rotate. The control device then determines the rotation angles it has passed through during the test run, or the data that indirectly characterize the rotation angles, and stores them in the data memory. It is possible to bring the carrier into a reference position before determining the data that characterize its movement. The reference position can be defined by means of contact of the latch or one of the latches against the active surface or one of the active surfaces. However, it is also possible to define the reference position by means of a switching position of a switch that can be switched when the carrier moves, particularly by means of the beginning and/or the end of a range in which the switch is activated by the carrier.

In the following, the invention will be explained in greater detail using an exemplary embodiment shown schematically in the drawing. This shows

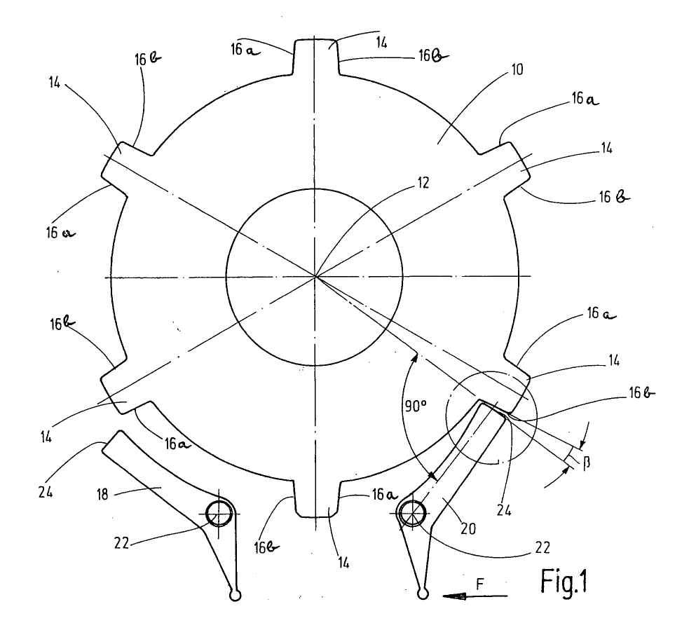

FIG. 1 a top view of a carrier configured as a blocking disk, with a blocking device, in a schematic representation.

In the drawing, a locking mechanism for a turnstile is shown. This mechanism has a blocking disk 10, which can be rotated about an axis of rotation 12. The blocking disk 10 is firmly connected with the blocking crossbars of the turnstile, so that when its rotational movement is blocked, the blocking turnstile that projects into a passageway of the security gate cannot be moved, and blocks the passageway. On the circumference of the blocking disk 10, which is essentially circular in the top view, cams 14 disposed at constant angular distances project in the radial direction, which cams have lateral first and second active surfaces 16a, 16b. In order to be able to block the rotational movement of the blocking disk 10, two latches 18, 20 are mounted close to the blocking disk 10, and can pivot about pivot axes 22. By means of pivoting about the pivot axes 22, the latches 18, 20 can be pivoted between a release position and a blocking position.

In the exemplary embodiment shown in FIG. 1, the left latch 18, with which the rotational movement of the blocking disk 10 can be blocked in the counterclockwise direction, is in the release position. The blocking disk 10 can therefore be moved counterclockwise about the axis of rotation 12. The right latch 20, in contrast, is in the blocking position. In this connection, a contact surface 24 lies against one of the second active surfaces 16b and inhibits rotation of the blocking disk 10. Pivoting of the latches 18, 20 between the release position and the blocking position takes place by means of a spring that brings about a reset force F, which permanently acts on the latch 18, 20, in each instance, and presses the latch 18, 20 into the release position in the absence of other forces. In order to move the latches 18, 20 into the blockade position, lifting magnets are provided, which counteract the reset force F when activated.

The turnstile is controlled by means of a control device, to release and block the passageway. The control device must be provided with the parameters that characterize the turnstile, after installation and before startup. Parameterization takes place automatically during a test run. In this connection, the following method of procedure is followed, according to the preferred exemplary embodiment:

The test run is started by activating a reset key. First, the blocking disk 10 is rotated, whereby the lifting magnets of the latches 18, 20 have no power applied to them, so that the reset force F of the spring holds both latches 18, 20 in the release position. Rotation of the blocking disk 10 in the counterclockwise direction takes place without being inhibited, and from this the information is obtained that the first latch 18 opens when there is no current. After a rotation angle of 360° has been covered, the movement of the blocking disk 10 is stopped and reversed, whereby the information is obtained that the second latch 20 also opens when there is no current. This movement is also stopped after a rotation angle of 360° has been covered.

Subsequently, the lifting magnet of the first latch 18 has current applied to it, so that the first latch 18 is moved into its blocking position. Then the blocking disk 10 is once again moved in the counterclockwise direction, until the movement is inhibited by contact of one of the first active surfaces 16a against the contact surface 24 of the first latch 18. This position serves as the reference position. Then the first latch 18 is moved into its release position, the rotation of the blocking disk 10 is continued, and the lifting magnet of the first latch 18 has power applied to it again. By means of contact against the following one of the first active surfaces 16a, the movement of the blocking disk 10 is inhibited once again. This process is repeated as often as necessary until the blocking disk 10 has covered a rotation angle of 360°. The security gate has a pulse transmitter that measures the number of pulses that occur between contact of the first latch 18 against one of the first active surfaces 16a and contact of the first latch 18 against the subsequent first active surface 16a. By means of conversion of the number of pulses into a rotation angle, the information is obtained that the first active surfaces 16a that face counterclockwise are disposed at an angle distance of 60° from one another. The method is repeated by turning clockwise and activating the second latch 20, and from this, the information is obtained that the second active surfaces 16b, which face clockwise, are also disposed at an angle distance of 60° from one another.

The data obtained are stored in a data memory of the control device, so that the control device is provided, by means of the automatic parameterization process, with the information that the security gate is a turnstile that can be blocked on both sides, whose control disks 10 can be blocked in both directions at angle distances of 60°, and that the latches 18, 20 are in the release position when there is no current.

If one or more of the active surfaces 16a, 16b shown in FIG. 1 can be differentiated from the remaining active surfaces, the test run can also be used to set a zero position of the turnstile, for example after a power failure. The ability to differentiate can be provided, for example, in that one of the cams 14 is wider or narrower than the remaining cams. The ability to differentiate the active surface in question then results from its distance from the adjacent active surfaces, which differs from the other distances between the active surfaces relative to one another. However, it is also possible that a control disk is mounted on the blocking disk 10, as described in the patent application DE 10 2007 036 360. The blocking disk then has three control cams that cover three of the cams 14.

In the former case, the zero position is defined by means of contact of one of the latches 18, 20 against an active surface of the cam that is structured to be wider or narrower. The zero position is set in a test run, in that the latch in question is brought into contact with the consecutive active surfaces, one after the other, and that the control device recognizes the zero position on the basis of the rotation angle of the blocking disk 10 between two positions in which its movement is inhibited. In the latter case, three zero positions are provided by means of contact of one of the latches 18, 20 against one of the active surfaces 16a, 16b, which are not covered by a control cam. Starting from a position in which one of the latches 18, 20 lies against one of the active surfaces 16a, 16b, the latch in question is moved into the release position, and the blocking disk 10 is moved by 60°. When the latch can then fall into its blocking position, the security gate is in its zero position.

In summary, the following should be stated:

The invention relates to a method for operation of a security gate for cyclical release of a passageway, whereby the security gate has a control device having a data memory and a data processing unit, and at least one blocking element that can be moved between a blocking position that blocks the passageway at a blocking location, and a pass-through position that releases the passageway, whereby the at least one blocking element is connected with a carrier 10 that can move in at least one direction of movement, which carrier has a first active surface 16a or multiple first active surfaces 16a, whereby the security gate has a locking device having at least one latch 18, 20, which can be moved between a first and a second end position and is intended to make contact with the first active surface 16a or one of the first active surfaces 16a in one of its end positions. According to the invention, it is provided that in a test run of the security gate, particularly after its startup, the control device moves the latch 18, 20 into at least one of its end positions, and moves the carrier 10 until its movement is inhibited by the latch 18, 20, that the movement of the carrier 10 is stopped after a predetermined path distance, if it is not inhibited by the latch 18, 20, that data that characterize the movement of the carrier 10 are determined by the control unit, and that the data processing unit determines parameters that characterize the security gate from the data that characterize the movement of the carrier 10, which parameters are stored in the data memory.

1. Method for operation of a security gate for cyclical release of a passageway, whereby the security gate has a control device having a data memory and a data processing unit, and at least one blocking element that can be moved between a blocking position that blocks the passageway at a blocking location, and a pass-through position that releases the passageway, whereby the at least one blocking element is connected with a carrier (10) that can move in at least one direction of movement, which carrier has a first active surface (16a) or multiple first active surfaces (16a), whereby the security gate has a locking device having at least one latch (18), which can be moved between a first and a second end position and is intended to make contact with the first active surface (16a) or one of the first active surfaces (16a) in one of its end positions, wherein in a test run of the security gate, particularly after its startup, the control device moves the latch (18) into at least one of its end positions, and moves the carrier (10) until its movement is inhibited by the latch (18), wherein the movement of the carrier (10) is stopped after a predetermined path distance, if it is not inhibited by the latch (18), wherein data that characterize the movement of the carrier (10) are determined by the control unit, and wherein the data processing unit determines parameters that characterize the security gate from the data that characterize the movement of the carrier (10), which parameters are stored in the data memory.

2. Method according to claim 1, wherein the carrier (10) can be moved in two opposite directions of movement, and is moved so far, in both directions of movement, until its movement is inhibited by the at least one latch (18), and wherein the movement of the carrier (10) is stopped after a predetermined path distance, if it is not inhibited by the at least one latch (18).

3. Method according to claim 2, wherein the carrier (10) has a second active surface (16b) or multiple second active surfaces (16b) that face(s) in the direction opposite the first active surface (16a) or opposite the first active surfaces (16a), and wherein the locking device has another latch (20) that can be moved between a first and a second end position and is intended to make contact with the second active surface (16b) or one of the second active surfaces (16b) in one of its end positions, and wherein in order to determine the data that characterize the movement of the carrier (10), both latches (18, 20) are moved into at least one of their end positions, one after the other.

4. Method according to claim 3, wherein the carrier (10) is moved in both directions of movement, until it is inhibited by one of the latches (18, 20) or until the predetermined path distance has been reached, in all possible combinations of the end positions of the latches.

5. Method according to claim 1, wherein during the test run, after inhibition of the movement of the carrier (10), the latch (18, 20) in question is brought into its other end position, in order to release the movement, wherein subsequently, the carrier (10) is moved further, wherein the latch (18, 20) is brought back into its end position that brings about inhibition, and wherein the carrier (10) is moved further until its movement is inhibited by the latch (18, 20).

6. Method according to claim 5, wherein the process of canceling out and restoring inhibition is repeated a predetermined number of times, particularly until the latch (18, 20) in question has made contact with each of the related active surfaces (16a, 16b).

7. Method according to claim 1, wherein during the test run, the carrier (10) is moved until the latch (18) or one of the latches (18, 20) lies against a reference active surface that can be differentiated from one of the further active surfaces (16a, 16b), or against a reference active surface from a group of reference active surfaces that can be differentiated from the further active surfaces (16a, 16b).

8. Method according to claim 1, wherein the carrier (10) is mounted in a fixed location, so as to rotate, and wherein the rotation angles over which it passes during the test run, or the data that characterize the rotation angles, are determined by the control unit and stored in the data memory.

9. Method according to claim 1, wherein the carrier (10) is brought into a reference position before the data that characterize its movement are determined.

10. Method according to claim 9, wherein the reference position is defined by contact of the latch (18, 20) or one of the latches (18, 20) against the active surface (16a, 16b) or one of the active surfaces (16a, 16b).

11. Method according to claim 9, wherein the reference position is defined by a switching position of a switch that can be switched when the carrier (10) moves.
